(19) United States
(12) Patent Application Publication
(10) Pub. No.: US 2006/0074846 A1
(43) Pub. Date: Apr. 6, 2006

(54) Interpage reference and calculation on a Web site

(76) Inventors: Jonathan Feinberg, Somerville, MA (US); Martin Wattenberg, Winchester, MA (US); Kushal Dave, Boston, MA (US); Michael Muller, Medford, MA (US)

Correspondence Address: LOTUS AND RATIONAL SOFTWARE;STEUBING MCGUINNESS, 125 NAGOG PARK, ACTON, MA, 01720, US

(21) Appl. No.: 10/959,470

(22) Filed: Oct. 6, 2004

(51) Int. Cl. G06F 17/30

(52) U.S. Cl. 707/1

(57) ABSTRACT

A Web site development tool such as WikiWiki allows a value to be referenced on a page other than the page on which the value is defined. The reference syntax may indicate the name of the page on which the value is defined and the value name, such as with a dot notation: <page name>.<value name>. Translation of Wiki source to HTML is executed in a manner which enables changes to the value in the value-defining page to be reflected in the value referencing page, i.e., the value reference is dynamic. Further, use of a symbolic name to represent a value is supported. Performance of calculations with a value and page aliasing are also supported.

### FIELD OF THE INVENTION

This invention is generally related to the World Wide Web, and more particularly to web site development and editing.

### BACKGROUND OF THE INVENTION

The World Wide Web of the Internet is a widely used resource for sharing information and ideas. Web pages are used commercially to advertise and sell products and services, and non-commercially to share information about various subjects of interest. Text, graphics and other features displayed by Web pages are generally written in HyperText Markup Language (“HTML”) format which indicates to a target computer how to display the Web page. HTML files include plain text, e.g., ASCII, with codes that a Web browser interprets to produce a particular effect on the target computer.

Historically, web site development was primarily done by people with technical knowledge such as computer programmers. HTML is perceived to be difficult for some non-technical people to use. However, growing use of the Web, the need to regularly update Web site content, and particularly the need for Web site co-construction created a need for a development tool such as “WikiWiki.” WikiWiki is a Web site development tool which includes server software that allows users to easily create and edit Web page content by generating or modifying simple “Wiki” source code using a Web browser. The server software translates the Wiki source code to HTML format. Wiki Web pages (“Wikis”) support hyperlinks, and have simple text syntax for creating new pages and crosslinks between internal pages. Text markers are employed to indicate text formatting, list items and headers. For example, a given Wiki implementation may render the text *foo* as the bold-faced foo, and may render “foo” as italic foo. In typical usage, one visits a WikiWiki web site, sees a page that requires editing, clicks a link labeled “Edit this page,” and is presented with a text field containing the Wiki source code of the page. Upon editing and submitting the text field, the page is updated to reflect the changes. In particular, the server software translates the Wiki source, including the changes, into HTML which is then provided to the user's computer. It should be noted that the term “Wiki” as used herein refers to both the tool by that name developed by Ward Cunningham and other tools known by various names which perform similar functions.

### SUMMARY OF THE INVENTION

The invention is predicated in-part upon recognition of some shortcomings of Wiki tools. For example, one shortcoming is that one page in a WikiWiki web site cannot refer to values on another page symbolically, or make the page reference itself symbolic. Given a WikiWiki page that contains a list of values, some Wiki tools might support adding the values together on the same page, but the values would have to be copied and pasted into other places such as a second page where they might be relevant. Consequently, updating the values on the first page would not result in the values on the second page being updated. Although some Wiki tools support referencing text on another page, integrated computations between pages is not supported.

In accordance with the present invention, a value may be referenced on a Wiki page other than the Wiki page on which the value is defined. Translation of value-referencing Wiki source to HTML is executed in a manner which enables changes to the value in the value-defining page to be reflected in the rendering of the value referencing page, i.e., the value reference is dynamic. Further, use of a symbolic name to represent a value is supported. Performance of calculations with a value and page aliasing may also be supported.

One advantage of dynamic value references is that updating of values in a Wiki Web site is facilitated. In particular, by dynamically referencing a defined value to the page on which the value is defined, changes to the value are reflected in all referencing pages without need for manual updates, and consequently without need for personal knowledge of which pages reference the value. The technique also advantageously reduces the effort required to implement a change because the value can be updated by changing only the value-defining page rather than all pages which use the value.

Support for use of symbolic names with formulas and defined values facilitate Web site development and editing by enabling use of recognizable terms rather than mathematical and logic expressions. Page aliasing facilitates development and editing by simplifying use of alternative sets of defined values. For example, a change in one line of a referencing page may cause selection of values from a different value-defining page, thereby obviating the need to change each individual value on the referencing page.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 is a block diagram which illustrates Wiki source code supporting use of symbolic names for values.

FIG. 2 is a block diagram which illustrates use of character strings.

FIG. 3 is a block diagram which illustrates Wiki source code for referring to values used in other pages.

FIG. 4 is a block diagram which illustrates page aliasing.

### DETAILED DESCRIPTION OF EXEMPLARY EMBODIMENTS

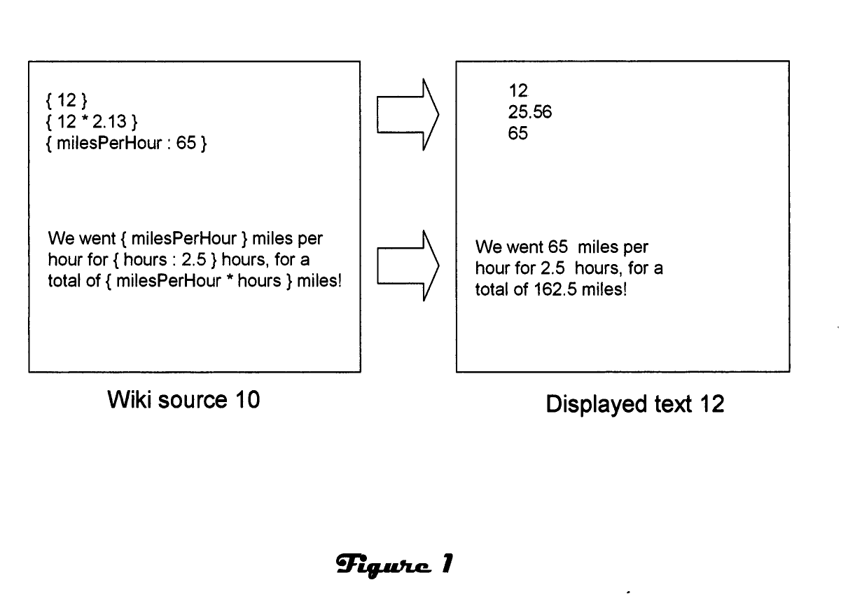

Referring to FIG. 1, a Web site development tool such as Wiki includes formulas in Wiki source code. Formulas support assigning symbolic names for values, references to named values within and across pages, and calculations using those named values. A formula is indicated in the Wiki source code by the use of curly brackets around an expression, e.g., {expression}. Expressions may be numbers, e.g., {12}, and mathematical expressions, e.g., {12*2.13}. Expressions may also be name assignments, e.g., {milesPerHour: 65}, where the value 65 is assigned to the name milesPerHour. The expression to the right of the colon, viz., 65, could also be a mathematical expression. Further, expressions may include named values such as {milesPerHour*hours}.

When rendered in HTML by the Wiki server software, a formula in Wiki source 10 is rendered as the formula's value in the displayed text 12. Hence, the formula {12} is rendered as 12 in the displayed text. Similarly, the formula {12*2.13} is rendered as 25.56 in the displayed text. In the case of a name assignment, the value of the formula is the value assigned to the name. Hence, {milesPerHour: 65} is rendered as 65.

Formulas may be included in text strings to produce a desired result. Continuing with the illustrated example, the text string We went {milesPerHour} miles per hour for {hours: 2.5} hours, for a total of {milesPerHour*hours} miles! in Wiki source 10 is rendered as We went 65 miles per hour for 2.5 hours, for a total of 162.5 miles! in the displayed text 12. In the illustrated example milesPerHour is assigned the value 65 outside of the text string, while hours is assigned the value 2.5 inside the text string and the formula {milesPerHour*hours} is defined inside the text string. Names may be assigned, and formulas may be defined, anywhere in a Wiki page including inside and outside of text strings. Once a name is assigned, any formula later on the page may refer to the assigned name. Undefined names are silently treated as numeric zero when used in a formula. As a design variant, undefined names could be treated as an error. It is an error to define the same name twice in one page.

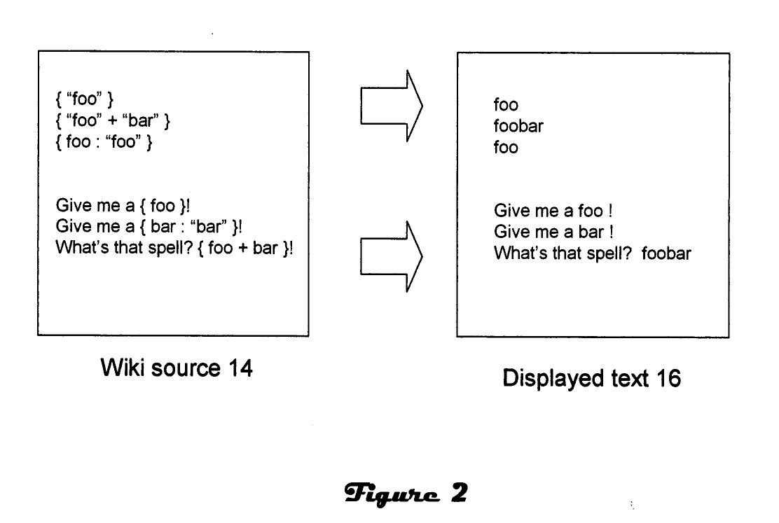

Referring to FIG. 2, character strings may be embedded in formulas and assigned to names. For example, the formula {“foo”} in Wiki source 14 is rendered as foo in the displayed text 16. Similarly, the name assignment {foo: “foo”} in Wiki source 14 is rendered as foo in the displayed text 16. However, the only operation supported on the embedded text strings is concatenation. Hence, {“foo”+“bar”} in the Wiki source 14 is rendered as foobar in the displayed text 16. The subsequent text string in Wiki source 14 with formulas Give me a {foo}! Give me a {bar: “bar”}! What's that spell? {foo+bar}! is render in the displayed text 16 as Give me a foo! Give me a bar! What's that spell? foobar.

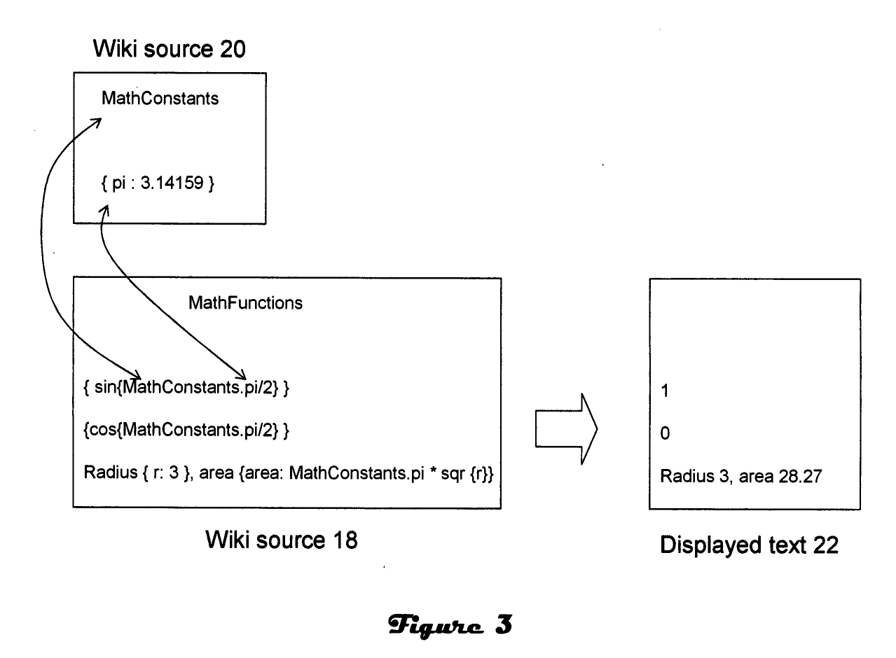

Referring to FIG. 3, a first page of Wiki source 18 can employ formulas and assigned values from a second page of Wiki source 20. For example, a formula may refer to a value name defined on another page using a dot notation. Every page has a name which is unique within the WikiWiki web site. In the illustrated example the Web site includes a unique MathConstants page and a unique MathFunctions page. The page named MathConstants contains the name assignment {pi: 3.14159}. The page named MathFunctions refers to the value pi in formulas as MathConstants.pi, where MathConstants indicates the page and pi indicates the value name. In particular, the dot notation prompts the Wiki server to refer to the MathConstants page to determine the value of pi. Hence, {sin{MathConstants.pi/2}} in the MathFunctions page of Wiki source is rendered as 1 in the displayed text 22, and {cos{MathConstants.pi/2}} is rendered as 0.

Mathematical functions may also be included to facilitate calculations. For example, a square function “sqr” may be included such that the Wiki source 18 Radius {r: 3}, area {area: MathConstants.pi*sqr {r}} is rendered as Radius 3, area 28.27 in the displayed text 22. Many other mathematical functions can be supported, such as those commonly found on an engineering calculator, advanced programming language or mathematics software. Those skilled in the art will recognize which functions are desirable for achieving a particular result.

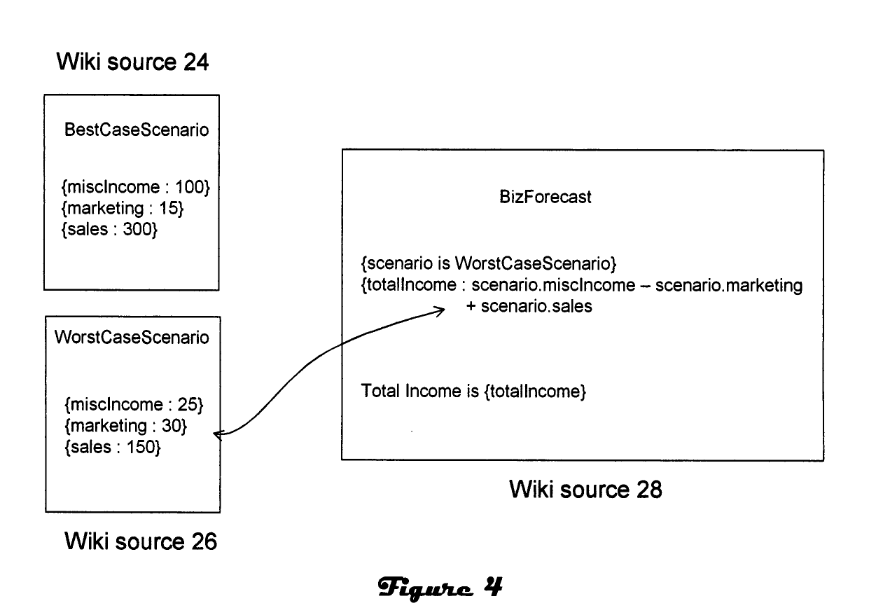

Referring to FIG. 4, page aliasing enables indirect reference to another page. In the illustrated example, two pages named BestCaseScenario and WorstCaseScenario in Wiki source 24 and 26, respectively, each define the values miscincome, marketing, and sales. Calculations are made by a third page of Wiki source 28 named BizForecast. On the BizForecast page, a page alias is assigned using the formula: {scenario is WorstCaseScenario}. Subsequent references to scenario.marketing, scenario.misclncome, and scenario.sales are therefore resolved to WorstCaseScenario.marketing, WorstCaseScenario.miscIncome, and WorstCaseScenario.sales respectively. Advantageously, to view results from an alternate scenario the user simply substitutes BestCaseScenario for WorstCaseScenario in the page alias formula and views the result, i.e., changes {scenario is WorstCaseScenario} to {scenario is BestCaseScenario}. A full-featured embodiment of this concept enables viewing of the results of different scenarios without editing the source code of the referencing page, e.g., BizForecast.

The translation of Wiki source to HTML is executed in a manner which enables changes in referenced pages to be reflected in the referring pages. This may be accomplished by executing translation upon each viewing. Alternatively, WikiWiki source code is initially translated into HTML and cached as HTML to avoid unnecessary re-translation. In either case, a parsing stage is employed in which referenced names and formulas are translated into their values based on the state of the respective defining pages prior to translating the formulas and names on the referencing page. In other words, reference is made to the defining pages to resolve the values before the values are employed in rendering a page to an HTML format that will be provided to the target computer.

In view of the description above, it will be understood by those of ordinary skill in the art that modifications and variations of the described and illustrated embodiments may be made within the scope of the inventive concepts. Moreover, while the invention is described in connection with various illustrative structures, those of ordinary skill in the art will recognize that the invention may be employed with other structures. Accordingly, the invention should not be viewed as limited except by the scope and spirit of the appended claims.

What is claimed is:

1. A Web site tool for rendering a target first format Web page to a second format Web page, comprising:
a translation engine including:
parsing logic operative upon the target first format Web page to resolve a value which references another first format Web page on which the value is defined; and
a translator operative to employ the value resolved by the parsing logic to render the second format Web page from the first format Web page.

2. The Web site tool of claim 1 wherein the parsing logic is further operative to identify the value from a symbolic name that represents the value in the target first format Web page.

3. The Web site tool of claim 1 wherein the parsing logic is further operative to perform a calculation to resolve the value.

4. The Web site tool of claim 1 wherein the parsing logic is further operative to identify the page on which the value is defined at least in-part by processing a page-aliasing formula in the target first format Web page.

5. A method for rendering a target first format Web page to a second format Web page, comprising the steps of:
parsing the target first format Web page to identify a value which references another first format Web page on which the value is defined
resolving the value; and
employing the resolved value to render the second format Web page from the first format Web page.

6. The method of claim 5 wherein the parsing step includes the further step of identifying the value from a symbolic name that represents the value in the target first format Web page.

7. The method of claim 5 wherein the resolving step includes the further step of performing a calculation to resolve the value.

8. The method of claim 5 including the further step of identifying the page on which the value is defined at least in-part by processing a page-aliasing formula in the target first format Web page.

9. A computer program product for rendering a target first format Web page to a second format Web page, comprising:
parsing logic operative upon the target first format Web page to resolve a value which references another first format Web page on which the value is defined; and
translation logic operative to employ the value resolved by the parsing logic to render the second format Web page from the first format Web page.

10. The Web site tool of claim 9 wherein the parsing logic is further operative to identify the value from a symbolic name that represents the value in the target first format Web page.

11. The Web site tool of claim 9 wherein the parsing logic is further operative to perform a calculation to resolve the value.

12. The Web site tool of claim 9 wherein the parsing logic is further operative to identify the page on which the value is defined at least in-part by processing a page-aliasing formula in the target first format Web page.

13. A product for rendering a target first format Web page to a second format Web page, comprising:
means for parsing the target first format Web page to identify a value which references another first format Web page on which the value is defined
means for resolving the value; and
means for employing the resolved value to render the second format Web page from the first format Web page.

14. The product of claim 13 wherein the parsing means includes means for identifying the value from a symbolic name that represents the value in the target first format Web page.

15. The product of claim 13 wherein the resolving means includes means for performing a calculation to resolve the value.

16. The product of claim 13 including means for identifying the page on which the value is defined at least in-part by processing a page-aliasing formula in the target first format Web page.
